(19) United States
(12) Patent Application Publication
(10) Pub. No.: US 2022/0267521 A1
(43) Pub. Date: Aug. 25, 2022

(54) METHOD FOR MANUFACTURING POLYAMIDE FIBERS

(71) Applicant: Universal Fibers, Inc., Bristol, VA (US)

(72) Inventors: Ryan M. Besch, Johnson City, TN (US); Stuart P. Fairgrieve, Kidlington (GB); Brendan McSheehy, JR., Abingdon, VA (US)

(21) Appl. No.: 17/674,373

(22) Filed: Feb. 17, 2022

Related U.S. Application Data
(60) Provisional application No. 63/151,157, filed on Feb. 19, 2021.

(51) Int. Cl. C08G 69/36; C08K 3/34; D01F 6/80; D01D 5/08; D01F 1/07

(52) U.S. Cl. CPC C08G 69/36; C08K 3/346; D01F 6/80; D01D 5/08; D01F 1/07; C08K 2201/011; C08K 2201/005

(57) ABSTRACT

The present invention is generally concerned with the use of additives in the form of nanoclays and/or organoclays as processing and property enhancers in melt-spinning formulations based on particular types of co-polyamides, which are used in the melt-spinning of fibers. The melt-spinning formulations of the present invention may comprise, consist essentially of, or consist of: (i) at least one co-polyamide and (ii) at least one nanoclay and/or organoclay.

### RELATED APPLICATIONS

This application claims the priority benefit under 35 U.S.C. § 119(e) of U.S. Provisional Patent Application Ser. No. 63/151,157 entitled “METHOD FOR MANUFACTURING POLYAMIDE FIBERS,” filed Feb. 19, 2021, the entire disclosure of which is incorporated herein by reference.

### BACKGROUND

### 1. Field of the Invention

The present invention is generally concerned with an improved method for the manufacture of melt-spun fibers. More particularly, the present invention is generally concerned with melt-spun fibers produced from co-polyamides, wherein at least one of the polyamides is prepared with an aliphatic dicarboxylic acid containing a large number of carbon atoms.

### 2. Description of the Related Art

Polyamides, also often referred to as nylons, are fiber-forming polymers, initially developed in the 1930's by DuPont in the USA and I. G. Farben in Germany. These were one of the first successful manmade fibers, and such fibers, and products based thereon, continue to be produced worldwide in significant quantities.

Polyamides may be prepared in several ways, but there are two main approaches which account for most production that use two types of starting materials:
(i) α, ω-amino acids or their equivalent lactams, such as polycaprolactam (PA6), polyundecanolactam (Polyamide 11), and polylauryllactam (Polyamide 12); and
(ii) Dicarboxylic acids, or derivatives thereof, plus diamines, which are usually first formed into a salt and subsequently polymerized. Examples include polyhexamethylene adipamide (Polyamide 6,6), polyhexamethylene sebacamide (Polyamide 6,10), polytetramethylene adipamide (Polyamide 4,6), and polypentamethylene adipamide (Polyamide 5,6).

Co-polyamides may also be made in other ways, such as being made with block copolymers and/or random copolymers incorporating mixtures of lactams with diamine-diacid salts, or mixtures of two or more diamine-diacid salts. Common examples of these co-polyamides include Polyamide 6/6,6, Polyamide 6/6,12, and Polyamide 6,6/6,12.

Co-polyamides of the type Polyamide 6/6,n or Polyamide 6,6/6,n, where n is a unit derived from an aliphatic, straight-chain or branched, saturated or unsaturated, dicarboxylic acid or derivative thereof with high number of carbon atoms, such as at least 20, have been prepared and in some cases commercialized. A number of co-polyamides of this type are well known as constituents of hot-melt adhesives. Further versions have, however, been prepared which can be used as thermoplastics in the preparation of extruded and molded articles. Such uses are described in U.S. Pat. Nos. 4,212,777, 4,384,111, 4,452,974, 4,680,379, 4,826,951, and 5,001,218, all of which are assigned to Rhone Poulenc.

Melt-spinning of fibers from such co-polyamides may provide fibers that exhibit increased flexibility and toughness relative to fibers spun from homo-polyamides, such as PA6 and PA6,6. Furthermore, such co-polyamides may be melt spun without plasticizers in the formulation, the presence of which can adversely affect various properties and characteristics of the resulting fibers. It is also noted that such co-polyamides may exhibit improved water-resistance over certain homo-polyamides. However, it is known to those skilled in the art that melt-spinning processes involving such co-polyamides are presently undesirable for several reasons. Potential difficulties include: (i) low melt strength upon exiting the spinneret, (ii) problems relating to various downstream processing activities, and (iii) problems with wound-up fibers relaxing, or contracting, on the bobbin, thereby resulting in yarn packages unsuitable for use in textile processes.

Thus, there still exists a need for a melt-spinning process and downstream processing activities that can address the above-referenced difficulties.

### SUMMARY

One or more embodiments are generally concerned with a method for the manufacture of co-polyamide fibers. Such methods generally comprise melt-spinning a formulation into a melt-spun fiber, wherein the formulation comprises: (a) one or more co-polyamides and (b) at least one nanoclay and/or at least one organoclay, wherein the nanoclay is a nanometer-sized particulate clay mineral and the organoclay is a chemically-modified nanometer-sized particulate clay mineral. Furthermore, the co-polyamides may comprise Polyamide Z/X,Y, Polyamide M,N/X,Y, or a combination thereof, wherein Z is a polymeric unit derived from an aliphatic α,ω-amino acid and/or lactam containing 4 to 12 carbon atoms, X and M are polymeric units derived from the same or different aliphatic diamines, N is a polymeric unit derived from an aliphatic dicarboxylic acid or a derivative thereof containing 2 to 12 carbon atoms, and Y is a polymeric unit derived from an aliphatic dicarboxylic acid or a derivative thereof containing 20 to 50 carbon atoms.

One or more embodiments are generally concerned with a melt-spun fiber. Generally, the melt spun fiber comprises: (a) at least one co-polyamide comprising Polyamide Z/X,Y, Polyamide M,N/X,Y, or a combination thereof; and (b) at least one nanoclay and/or at least one organoclay. Additionally, Z is a polymeric unit derived from an aliphatic α,ω-amino acid and/or lactam containing 4 to 12 carbon atoms, X and M are polymeric units derived from an aliphatic diamine, N is a polymeric unit derived from an aliphatic dicarboxylic acid or a derivative thereof containing 2 to 12 carbon atoms, and Y is a polymeric unit derived from an aliphatic dicarboxylic acid or a derivative thereof containing 20 to 50 carbon atoms. Furthermore, the nanoclay and the organoclay are in the form of nanoparticles with an average particle size of not more than 500 nm.

One or more embodiments are generally concerned with a method for producing a melt-spun fiber. Generally, the method comprises melt-spinning a melt formulation into said melt-spun fiber, wherein the melt formulation comprises: (a) at least one co-polyamide comprising Polyamide Z/X,Y, Polyamide M,N/X,Y, or a combination thereof, and (b) at least one nanoclay and/or at least one organoclay. Additionally, Z is a polymeric unit derived from an aliphatic α,ω-amino acid and/or lactam containing 4 to 12 carbon atoms, X and M are polymeric units derived from an aliphatic diamine, N is a polymeric unit derived from an aliphatic dicarboxylic acid or a derivative thereof containing 2 to 12 carbon atoms, and Y is a polymeric unit derived from an aliphatic dicarboxylic acid or a derivative thereof containing 20 to 50 carbon atoms. Furthermore, the nanoclay and the organoclay are in the form of nanoparticles with an average particle size of not more than 500 nm.

One or more embodiments are generally concerned with a melt-spun fiber. Generally, the melt spun fiber comprises: (a) at least 90 weight percent of at least one co-polyamide comprising Polyamide Z/X,Y, Polyamide M,N/X,Y, or a combination thereof, and (b) at least 0.5 weight percent of at least one nanoclay and/or at least one organoclay. Additionally, Z is a polymeric unit derived from caprolactam, X and M are polymeric units derived from 1,6-diaminohexane, N is a polymeric unit derived from adipic acid, and Y is a polymeric unit derived from a dimerized fatty acid containing 20 to 50 carbon atoms. Furthermore, the nanoclay and the organoclay are in the form of nanoparticles with an average particle size of not more than 500 nm.

### DETAILED DESCRIPTION

It has been discovered that the melt-spinning and fiber downstream processing of co-polyamides can be markedly improved by the inclusion of low-to-moderate loadings of aluminosilicates, also referred to as “nanoclays,” and/or their chemically treated form (i.e., “organoclays”). These nanoclays and organoclays may have very small particle sizes, which allows them to readily disperse throughout the melt-spinning formulation.

The present invention is generally concerned with the use of additives in the form of nanoclays and/or organoclays as processing and property enhancers in melt-spinning formulations based on particular types of co-polyamides, which are used in the melt-spinning of fibers. Thus, as discussed in greater detail below, the melt-spinning formulations of the present invention may comprise, consist essentially of, or consist of: (i) at least one co-polyamide and (ii) at least one nanoclay and/or at least one organoclay.

In one or more embodiments, the melt-spinning formulations may comprise at least 50, 60, 65, 70, 75, 80, 85, 90, 95, 99, 99.5, or 99.8 weight percent of at least 1, 2, 3, or 4 co-polyamides, based on the total weight of the formulation or fiber.

Additionally or alternatively, in one or more embodiments, the melt-spinning formulations may comprise at least 0.1, 0.2, 0.3, 0.4, 0.5, 0.6, 0.7, 0.8, 0.9, or 1.0 weight percent and/or not more than 25, 20, 15, 10, or 5 weight percent of one or more nanoclays and/or organoclays, based on the total weight of the formulation or fiber. In certain embodiments, the melt-spinning formulations may comprise in the range of 0.1 to 25, 0.5 to 10, or 1 to 5 weight percent of at least 1, 2, 3, 4, or 5 nanoclays and/or organoclays, based on the total weight of the formulation or fiber.

The various characteristics and properties of the co-polyamides, the nanoclays, and the resulting end products are described below. It should be noted that, while all of the following characteristics and properties may be listed separately, it is envisioned that each of the following characteristics and/or properties of the following co-polyamides, the nanoclays, and the resulting end products are not mutually exclusive and may be combined and present in any combination.

In one or more embodiments, the co-polyamides may be of the types: (i) Polyamide Z/X,Y and/or (ii) Polyamide M,N/X,Y, wherein Z is a polymeric unit derived from an aliphatic α,ω-amino acid or a lactam; X and M are polymeric units derived from the same, or different, aliphatic diamines; N is a polymeric unit derived from an aliphatic dicarboxylic acid comprising 2 to 12 carbon atoms or a derivative thereof, and Y is a polymeric unit derived from an aliphatic dicarboxylic acid comprising 15 to 50 carbon atoms, or a derivative thereof.

Additionally or alternatively, in one or more embodiments, Z is a polymeric unit derived from γ-butyrolactam, δ-valerolactam, ε-caprolactam, ω-dodecanelactam, ω-aminoundecanoic acid, or combinations thereof.

Additionally or alternatively, in one or more embodiments, X and M may be the same, or different, and are polymeric units derived 1,2-diaminoethane, 1,3-diaminopropane, 1,4-diaminobutane, 1,5-diaminopentane, 1,6-diaminohexane, 1,10-diaminodecane, 1,12-diaminododecane, or combinations thereof.

Additionally or alternatively, in one or more embodiments, N is a polymeric unit derived from malonic acid, succinic acid, glutaric acid, adipic acid, pimelic acid, suberic acid, azelaic acid, sebacic acid, 1,10-decanedicarboxylic acid, derivatives thereof, or combinations thereof.

Additionally or alternatively, in one or more embodiments, Y is a polymeric unit derived from thapsic acid, octadecanedioic acid, eicosanedioic acid, dimerized fatty acids with about 20 to about 50 carbon atoms, derivatives thereof, or combinations thereof.

Dimerized fatty acids and derivatives thereof, often referred to as “dimer acids,” may be synthesized from monomeric unsaturated monocarboxylic acids having from about 10 to about 25 carbon atoms (e.g., oleic acid and/or linoleic acid) or their esters, using well-known synthetic routes. Once processes have been carried out to remove monocarboxylic and tricarboxylic molecules, a pure, normally branched, normally unsaturated, dicarboxylic acid remains. Optionally, the dimer acid product may be hydrogenated to remove the unsaturated units. The most common product of this type is a C36 dimer acid. Such dimeric acids, along with various others, are commercially available from a number of manufacturers. In one or more embodiments, Y is a polymeric unit derived from a C36 dimer acid or a derivative thereof.

It should be noted that the co-polyamides utilized in the practice of the present invention may contain any suitable proportion of the “X,Y segment” noted above. As used herein, the “X,Y segment” refers to the total polymeric unit derived from X and Y. In one or more embodiments, the co-polyamides may comprise at least 1, 2, 3, 4, 5, 6, 7, 8, 9, or 10 weight percent and/or not more than 60, 50, 40, or 30 weight percent of the X,Y segment, based on the total weight of the co-polyamide. In certain embodiments, the co-polyamides may comprise in the range of 5 to 60 or 10 to 30 weight percent of the X,Y segment, based on the total weight of the co-polyamide.

Any or all of the substances used to provide polymeric units Z, X, Y, M, and N described above may be derived from petrochemical and/or from renewable resources, including from recycled or recovered materials.

Specific examples of co-polyamides suitable for use in the method of the present invention include, but are not limited to, Polyamide 6/6,18, Polyamide 6,6/6,18, Polyamide 6/6,36, and/or Polyamide 6,6/6,36. Exemplary co-polyamides may include Ultramid© Flex F29 and Ultramid© Flex F38 by BASF.

As used herein, “nanoclays” may be defined as nanometer-sized particles of layered aluminosilicate minerals of the group known as clay minerals, which form part of the larger class of phyllosilicate minerals. These materials may be derived from natural or synthetic sources.

The basic unit of the phyllosilicates is a sheet of linked [SiO₄] tetrahedra, three oxygens from each tetrahedral unit being shared, thus giving the basic unit Si₄O₁₀(OH)₂. These are combined in two-layer or three-layer units with a further layer of a different chemical composition. In the case of the clay minerals, this may be brucite (Mg₆(OH)₆), and the minerals may be in the form of minute, platy, crystals. In many cases, the clay minerals may also contain loosely bonded cations, which can easily be exchanged for other species.

Nanoclays suitable for use as additives in the present invention include, for example, montmorillonite, bentonite, kaolinite, illite, hectorite, halloysite, or combinations thereof. In certain embodiments, the nanoclays can be montmorillonite.

As used herein, “organoclays” may be defined as chemically modified nanoclays, derived from the original (nano)clay mineral by exchange of some or all of the above-noted loosely bound cations with organo-cations, typically quaternary alkyl ammonium ions. This treatment increases the organophilicity of the nanoclay, affecting layer spacing and exfoliation of the mineral, and improving the dispersion of the nanoparticles within the polymer matrix, and the stability of the dispersion. An exemplary organoclay that may be used in accordance with the present disclosure is BYK-MAX CT 4255 from BYK, which is an organo-modified phyllosilicate.

Organoclays suitable for use as additives in the present invention may be based on any of the minerals noted above in regard to the nanoclays. In various embodiments, the nanoclay can be a chemically-modified montmorillonite.

In one or more embodiments, the nanoclays and/or organoclays used as additives in the present invention are in the form of nanoparticles with a longest axis particle size of at least 1, 2, 3, 4, 5, 6, 7, 8, 9, or 10 nm and/or not more than 500, 400, 300, 200, or 100 nm. In certain embodiments, the nanoclays and/or organoclays have a longest axis particle size in the range of 1 to 500 nm or 10 to 100 nm. As used herein, the “longest axis particle size” refers to the longest measurable width or length exhibited by a particle.

In one or more embodiments, the nanoclays and/or organoclays used as additives in the present invention are in the form of nanoparticles with an average particle size of at least 1, 2, 3, 4, 5, 6, 7, 8, 9, or 10 nm and/or not more than 500, 400, 300, 200, 100, 90, 80, 70, 60, or 50 nm.

The nanoclays and/or organoclays may be incorporated into the melt-spinning formulation using any suitable means. Such means include, but are not limited to, direct mixing with polymer pellets or powder; direct mixing into the molten polymer; formation of a liquid dispersion of the nanoclay and/or organoclay, followed by addition of the dispersion to polymer pellets or powder, or to molten polymer; and/or formation of a masterbatch of nanoclay and/or organoclay, followed by addition of the masterbatch to polymer pellets or powder, or to molten polymer. In the last case, the masterbatch carrier polymer may be the same as, or different to, the matrix polymer of the melt-spinning polymer formulation. In embodiments where a different polymer matrix is used in the masterbatch, the resulting melt-spinning formulation may comprise at least 2, 3, or 4 different types of co-polyamides, which may include any of the co-polyamides described herein.

Optionally, further adjuvants may be incorporated into the melt-spinning formulation utilized in the practice of the invention. These may include, but are not limited to, one or more of particulate (nano)fillers, fibrous (nano)fillers, colorants, antioxidants, light stabilizers, antimicrobials, antistatics, lubricants, processing aids, flame retardants, or combinations thereof. In certain embodiments, the melt-spinning formulation may comprise one or more flame retardant additives, such as one or more non-halogenated flame retardant additive(s). Exemplary non-halogenated flame retardants can include a phosphate ester, a phosphonate, a phosphinate, an ammonium polyphosphate, a rescorcinoldiphosphoric acid tetraphenylester, phosphinic acid salts, or combinations thereof.

Additionally or alternatively, in one or more embodiments, the melt-spinning formulations may comprise at least 0.1, 0.2, 0.3, 0.4, 0.5, 0.6, 0.7, 0.8, 0.9, or 1.0 weight percent and/or not more than 15, 10, 9, 8, 7, 6, 5, 4, 3, or 2 weight percent of one or more non-halogenated flame retardants, based on the total weight of the formulation or fiber.

The melt-spinning formulations described herein may be melt-spun into fibers, monofilaments, and/or multifilament yarns, using equipment and methods known to those skilled in the art. For example, any conventional melt spinning spinneret device may be used. The spinnerette heads may operate at temperatures above the melting point of the co-polyamides and contain multiple spinnerette holes. The melt spinning device can comprise a single screw extruder, such as a 24:1 L/D single screw extruder. Furthermore, the melt spinning device may also contain an air-cooled quench unit downstream of the spinneret to rapidly cool the newly-formed melt-spun fibers.

The fibers, monofilaments, and/or multifilament yarns may be subjected to downstream processing, either as part of a continuous process or in a later process carried out on the collected and wound as-spun fibers, monofilaments, or multifilament yarns, using such techniques that are well known to those skilled in the art. The downstream processes may include, but are not limited to, one or more of spin-finishing with a lubricant, single-stage or multi-stage drawing, annealing, crimping, entangling, twisting, and/or false-twisting.

In one or more embodiments, after leaving the spinneret, the melt-spun fibers, monofilaments, and/or multifilament yarns may be: (i) cooled in a quench unit (e.g., an air-cooled quench unit): (ii) subjected to spin-finishing so as to apply a spin finish onto the fibers, monofilaments, and/or multifilament yarns; and (iii) wound on a slow-speed winder at about 500 m/min. The resulting fibers, monofilaments, and/or multifilament yarns may be undrawn in such embodiments.

Alternatively, in one or more embodiments, after leaving the spinneret, the melt-spun fibers, monofilaments, and/or multifilament yarns may be: (i) cooled in a quench unit (e.g., an air-cooled quench unit): (ii) subjected to spin-finishing so as to apply a spin finish onto the fibers, monofilaments, and/or multifilament yarns; (iii) drawn on heated godets to a total draw ratio of at least 2:1, 3:1, or 4:1; and (iv) wound on a winder at about 2,500 m/min. The resulting fibers, monofilaments, and/or multifilament yarns may be considered drawn in such embodiments.

Due to the incorporation of the nanoclays and/or the organoclays described herein, the resulting fibers, monofilaments, and/or multifilament yarns formed in accordance with the present disclosure may exhibit superior elongation and tenacity properties.

In one or more embodiments, the undrawn fibers, monofilaments, and/or multifilament yarns formed in accordance with the present disclosure may exhibit a tenacity at max of at least 0.50, 0.55, 0.60, 0.65, or 0.70 gf/den and/or less than 1.3, 1.25, 1.2, 1.15, 1.1, 1.05, 1.0, 0.95, 0.90, 0.85, or 0.80 gf/den as measured according to ASTM D 2101-94. As used herein, the term “undrawn” refers to fibers, monofilaments, and/or multifilament yarns that have not been subjected to drawing treatment.

In one or more embodiments, the drawn fibers, monofilaments, and/or multifilament yarns formed in accordance with the present disclosure may exhibit a tenacity at max of at least 0.50, 0.55, 0.60, 0.65, or 0.70 and/or less than 1.3, 1.25, 1.2, 1.15, 1.1, 1.05, 1.0, 0.95, 0.90, 0.85, or 0.80 gf/den as measured according to ASTM D 2101-94. As used herein, term “drawn” refers to fibers, monofilaments, and/or multifilament yarns that have been previously subjected to a drawing post treatment.

In one or more embodiments, the undrawn fibers, monofilaments, and/or multifilament yarns formed in accordance with the present disclosure may exhibit an elongation at max of at least 300, 350, 400, 450, or 500 gf/den and/or less than 900, 850, 800, 750, 700, 650, 600, or 550 gf/den as measured according to ASTM D 2101-94.

In one or more embodiments, the drawn fibers, monofilaments, and/or multifilament yarns formed in accordance with the present disclosure may exhibit an elongation at max of at least 5, 10, 15, 20, 25, or 30 gf/den and/or less than 100, 90, 80, 70, 60, or 50 gf/den as measured according to ASTM D 2101-94.

In one or more embodiments, the undrawn fibers, monofilaments, and/or multifilament yarns formed in accordance with the present disclosure may exhibit a tensile extension at break of at least 200, 225, 250, 275, or 300 percent and/or less than 800, 700, 600, or 500 percent as measured according to ASTM D 2101-94.

In one or more embodiments, the undrawn fibers, monofilaments, and/or multifilament yarns formed in accordance with the present disclosure may comprise a denier per filament (dpf) of at least 1, 2, 3, 4, 5, 6, 7, 8, 9, 10, 11, 12, 13, 14, or 15 and/or less than 75, 70, 65, 60, 55, 50, 45, or 40 dpf.

In one or more embodiments, the drawn fibers, monofilaments, and/or multifilament yarns formed in accordance with the present disclosure may comprise a denier per filament (dpf) of at least 1, 2, 3, 4, 5, or 6 and/or less than 20, 15, 10, 9, 8, or 7 dpf.

In one or more embodiments, the undrawn fibers, monofilaments, and/or multifilament yarns formed in accordance with the present disclosure may comprise a denier of at least 1,000, 1,250, 1,500, 1,750, or 1,800 and/or less than 5,000, 4,000, 3,000, or 2,000.

In one or more embodiments, the drawn fibers, monofilaments, and/or multifilament yarns formed in accordance with the present disclosure may comprise a denier of at least 10, 25, 50, 75, 100, 125, 150, 175, or 200 and less than 1,000, 900, 800, 700, 600, or 500.

The fibers, monofilaments, and/or multifilament yarns formed in accordance with the present disclosure may have any desired cross-sectional shape. For instance, the fibers, monofilaments, and/or multifilament yarns formed in accordance with the present disclosure may have a tri-lobal cross-sectional shape, a round cross-sectional shape, a Y-shaped cross-sectional shape, or a C-shaped cross-sectional shape.

The fibers, monofilaments, and multifilament yarns made by the method of the present disclosure may be used in the manufacture of a range of goods, including, but not limited to, woven textiles, knitted textiles, nonwoven textiles, and floor coverings.

In various embodiments, the fibers, monofilaments, and multifilament yarns of the present disclosure may also contain a non-halogenated flame retardant and be considered “No-Drip” fibers, monofilaments, and multifilament yarns. Such fibers, monofilaments, and multifilament yarns may be used to manufacture No-Drip textiles, including No-Drip clothing. As used herein, “No-Drip” refers to flame-retardant articles that have a flame retardant incorporated therein.

Additional advantages of the various embodiments of the invention will be apparent to those skilled in the art upon review of the disclosure herein. It will be appreciated that the various embodiments described herein are not necessarily mutually exclusive unless otherwise indicated herein. For example, a feature described or depicted in one embodiment may also be included in other embodiments, but is not necessarily included. Thus, a variety of combinations and/or integrations of the specific embodiments are encompassed by the disclosures provided herein.

This invention can be further illustrated by the following examples of embodiments thereof, although it will be understood that these examples are included merely for the purposes of illustration and are not intended to limit the scope of the invention unless otherwise specifically indicated.

### EXAMPLES

### Examples 1-4

Four different melt-spinning formulations were created with a nanoclay (i.e., BYK-MAX CT 4255 from BYK) and a premade mixture of Ultramid© Flex F29 by BASF and a non-halogenated flame retardant.

Before producing each of the four formulations, a masterbatch was produced by compounding the nanoclay in Ultramid© Flex F29 by BASF so that the resulting masterbatch contained 20 weight percent of nanoclay and 80 weight percent of the Ultramid© Flex F29. This resulting masterbatch was then used to produce the four formulations depicted in TABLE 1, below. More particularly, the masterbatch was combined with the premade mixture at weight ratios of 5/95, 10/90, 15/85, and 20/80, so that the resulting melt-spinning formulations contained 1, 2, 3, and 4 weight percent of nanoclay.

Undrawn yarns were spun with the four melt-spinning formulations via a melt spinning line with a 1″, 24:1 L/D screw and a single 30-hole trilobal spinneret at a standard process temperature for the polyamides. The resulting yarns were then cooled in an air-cooled quench unit, subjected to a spin finish where the yarns were coated with a spin finish lubricant, and then wound on a slow speed winder, at approximately 500 m/min. The undrawn yarns were produced to have a denier of approximately 1,850 and to have 60 filaments at 30 dpf.

TABLE 1

| | Nanoclay | | Tenacity at Max | Elongation at | Tensile Extension |
|---|---|---|---|---|---|
| Sample | (Wt. %) | Denier | (gf/den) | Max (%) | at Break (%) |
| Example 1 | 1% | 1,835-1,861 | 0.926-1.198 | 466.3-546.1 | 381.7-455.0 |
| Example 2 | 2% | 1,869-1,870 | 0.722-0.907 | 401.7-622.4 | 302.7-355.9 |
| Example 3 | 3% | 1,852-1,877 | 0.713-0.935 | 426.6-839.5 | 315.0-349.2 |
| Example 4 | 4% | 1,847-1,862 | 0.907-1.238 | 404.1-489.9 | 334.9-374.6 |

The tenacity at max, elongation at max, and the tensile extension at break were measured for all of the formed yarns. These properties were measured according to ASTM D2104-94 using an Instron 2530-500N. The ranges of these measured characteristics are provided in TABLE 1.

### Example 5

Fully drawn and fully oriented yarns were spun using the melt-spinning formulation of Example 4 (i.e., the formulation comprising 4 weight percent of nanoclay). The yarns were spun via a melt spinning line with a 2″ 24:1 L/D screw with a mixing zone and a pair of 36-hole round spinnerets at a standard process temperature for the polyamides. The resulting yarns were then cooled in an air-cooled quench unit, subjected to a spin finish where the yarns were coated with a spin finish lubricant, drawn on heated godet rollers with a total draw ratio of 3:1 and then wound on a winder, at approximately 2,500 m/min. The drawn yarns were produced to have a denier of approximately 221 and to have 36 filaments at about 6.1 dpf.

The tenacity at max and elongation at max were measured for all of the formed yarns. These properties were measured according to ASTM D2104-94 using an Instron 2530-500N. The yarns exhibited a tenacity at max in the range of 5.14 to 5.45 gf/den and an elongation at max in the range of 31.0 to 38.8.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

When a numerical sequence is indicated, it is to be understood that each number is modified the same as the first number or last number and is in an “or” relationship, i.e., each number is “at least,” or “up to” or “not more than” as the case may be. For example, “at least 10 20, 30, 40, or 50 weight percent and/or not more than 90, 80, or 70 weight percent . . . ” means the same as “at least 10 weight percent, or at least 20 weight percent, or at least 30 weight percent, or at least 40 weight percent, or at least 50 weight percent and/or not more than 90 weight percent, or not more than 80 weight percent, or not more than 70 weight percent.”

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A melt-spun fiber comprising:
(a) at least one co-polyamide, wherein said co-polyamide comprises Polyamide Z/X,Y, Polyamide M,N/X,Y, or a combination thereof, wherein—
Z is a polymeric unit derived from an aliphatic α,ω-amino acid and/or lactam containing 4 to 12 carbon atoms,
X and M are polymeric units derived from an aliphatic diamine,
N is a polymeric unit derived from an aliphatic dicarboxylic acid or a derivative thereof containing 2 to 12 carbon atoms, and
Y is a polymeric unit derived from an aliphatic dicarboxylic acid or a derivative thereof containing 20 to 50 carbon atoms; and
(b) at least one nanoclay and/or at least one organoclay, wherein said nanoclay and said organoclay are in the form of nanoparticles with an average particle size of not more than 500 nm.

2. The melt-spun fiber according to claim 1, wherein said melt-spun fiber comprises at least 90 weight percent of said at least one co-polyamide.

3. The melt-spun fiber according to claim 2, wherein said melt-spun fiber comprises at least 0.1 weight percent and not more than 5 weight percent of said nanoclay or said organoclay.

4. The melt-spun fiber according to claim 1, wherein said melt-spun fiber comprises a non-halogenated flame retardant.

5. The melt-spun fiber according to claim 1, wherein said Z is a polymeric unit derived from caprolactam, said X and said M are polymeric units derived from 1,6-diaminohexane, said N is a polymeric unit derived from adipic acid, and said Y is a polymeric unit derived from a dimerized fatty acid.

6. The melt-spun fiber according to claim 1, wherein said at least one co-polyamide comprises at least 10 weight percent and not more than 60 weight percent of an X,Y segment, based on the total weight of said at least one co-polyamide.

7. The melt-spun fiber according to claim 1, wherein said melt-spun fiber comprises said nanoclay, wherein said nanoclay comprises montmorillonite, bentonite, kaolinite, illite, hectorite, halloysite, or combinations thereof.

8. The melt-spun fiber according to claim 1, wherein said melt-spun fiber comprises said organoclay, wherein said organoclay is a chemically-modified montmorillonite.

9. A textile comprising said melt-spun fiber according to claim 1.

10. A method for producing a melt-spun fiber comprising melt-spinning a melt formulation into said melt-spun fiber, said melt formulation comprising:
(a) at least one co-polyamide, wherein said co-polyamide comprises Polyamide Z/X,Y, Polyamide M,N/X,Y, or a combination thereof, wherein—
Z is a polymeric unit derived from an aliphatic α,ω-amino acid and/or lactam containing 4 to 12 carbon atoms,
X and M are polymeric units derived from an aliphatic diamine,
N is a polymeric unit derived from an aliphatic dicarboxylic acid or a derivative thereof containing 2 to 12 carbon atoms, and
Y is a polymeric unit derived from an aliphatic dicarboxylic acid or a derivative thereof containing 20 to 50 carbon atoms; and
(b) at least one nanoclay and/or at least one organoclay, wherein said nanoclay and said organoclay are in the form of nanoparticles with an average particle size of not more than 500 nm.

11. The method according to claim 10, wherein said melt formulation comprises at least 90 weight percent of said at least one co-polyamide.

12. The method according to claim 11, wherein said melt formulation comprises at least 0.1 weight percent and not more than 5 weight percent of said nanoclay or said organoclay.

13. The method according to claim 10, wherein said melt formulation comprises a non-halogenated flame retardant.

14. The method according to claim 10, wherein said Z is a polymeric unit derived from caprolactam, said X and said M are polymeric units derived from 1,6-diaminohexane, said N is a polymeric unit derived from adipic acid, and said Y is a polymeric unit derived from a dimerized fatty acid.

15. The method according to claim 10, wherein said at least one co-polyamide comprises at least 10 weight percent and not more than 60 weight percent of an X,Y segment, based on the total weight of said at least one co-polyamide.

16. The method according to claim 10, wherein said melt formulation comprises said nanoclay, wherein said nanoclay comprises montmorillonite, bentonite, kaolinite, illite, hectorite, halloysite, or combinations thereof.

17. The method according to claim 10, wherein said melt formulation comprises said organoclay, wherein said organoclay is a chemically-modified montmorillonite.

18. The method according to claim 10, further comprising subjecting said melt-spun fiber to downstream processing, wherein said downstream processing comprises spin-finishing, single-drawing, multi-stage drawing, annealing, crimping, entangling, twisting, false-twisting, or a combination thereof.

19. A melt-spun fiber comprising:
(a) at least 90 weight percent of at least one co-polyamide, wherein said co-polyamide comprises Polyamide Z/X,Y, Polyamide M,N/X,Y, or a combination thereof, wherein—
Z is a polymeric unit derived from caprolactam,
X and M are polymeric units derived from 1,6-diaminohexane,
N is a polymeric unit derived from adipic acid, and
Y is a polymeric unit derived from a dimerized fatty acid; and
(b) at least 0.5 weight percent of at least one nanoclay and/or at least one organoclay, wherein said nanoclay and said organoclay are in the form of nanoparticles with an average particle size of not more than 500 nm.

20. The melt-spun fiber according to claim 19, wherein said melt-spun fiber comprises a non-halogenated flame retardant.
